(19) United States
(12) Patent Application Publication
(10) Pub. No.: US 2009/0246491 A1
(43) Pub. Date: Oct. 1, 2009

(54) Co-Extruded Film Structures of Polypropylene Impact Copolymer with Other Copolymers

(75) Inventor: Leonardo Cortes, Webster, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/476,215

(22) Filed: Jun. 1, 2009

Related U.S. Application Data
(63) Continuation-in-part of application No. 11/026,848, filed on Dec. 30, 2004.

(51) Int. Cl. B32B 7/02; B32B 27/32

(52) U.S. Cl. 428/213; 428/517; 428/340

(57) ABSTRACT

It has been discovered that the properties of sheet or film materials or structures can be improved by co-extruding a polypropylene based impact copolymer core layer with at least a second polyolefin that may be a high density polyethylene (HDPE), medium density polyethylene (MDPE), linear low density polyethylene (LLDPE), and/or low density polyethylene (LDPE). Improvements can include, but are not limited to, reduced haze and increased gloss. These sheet or film materials may be co-extruded with other resins or laminated with other materials after extrusion.

### CROSS-REFERENCE TO RELATED APPLICATIONS

The present application is a continuation-in-part to U.S. patent application Ser. No. 11/026,848 filed on Dec. 30, 2004 and claims priority thereto.

### FIELD

The invention is related to methods and compositions useful to improve the manufacture of sheets or blown films containing polypropylene. It relates more particularly to methods for making laminates of impact copolymers also known as heterophasic copolymers with polyethylene to improve the characteristics thereof, as well as the resulting film and sheet materials.

### BACKGROUND

Among the different possible ways to convert polymers into films, the blown film process with air-cooling is probably the most economical and also the most widely used. This is because films obtained by blowing have a tubular shape, which makes them particularly advantageous in the production of bags for a wide variety of uses (e.g. bags for urban refuse, bags used in the storage of industrial materials, for frozen foods, carrier bags, etc.) as the tubular structure enables the number of welding joints required for formation of the bag to be reduced when compared with the use of flat films, with consequent simplification of the process. Moreover, the versatility of the blown-film technique makes it possible, simply by varying the air-insufflation parameters, to obtain tubular films of various sizes, therefore avoiding having to trim the films down to the appropriate size as is necessary in the technique of extrusion through a flat head.

To date the application of polypropylene (PP) for blown film technology has been restricted to niche applications or technologies, such as PP blown film process with water contact cooling ring for highly transparent packaging film and PP used as a sealing or temperature resistance layer in multilayer structures. Recently, blown film producers are showing more interest developing new structures with polypropylene. Polypropylene is expected to offer some advantages (e.g. heat resistance, puncture resistance, downgauge) compared to polyethylene. It has been seen that impact copolymers (or heterophasic copolymers) with low melt flow rate, such as Total Petrochemicals PP 4180 polypropylene and Total Petrochemicals PP 4170 polypropylene, have high melt strength and good mechanical properties that enable blown extrusion in monolayer structures with good bubble stability.

Possible applications of monolayer and multilayer structures made using impact copolymers include industrial bags, bags for frozen foods, carrier bags, heavy-duty shipping sacks, among others. There is a constant need for materials having improved properties for particular applications.

### SUMMARY

There is provided, in one form, a co-extruded film or sheet structure that includes a core layer containing at least one broad molecular weight distribution ethylene/propylene rubber impact-modified heterophasic copolymer (ICP). The co-extruded structure also includes at least one skin on either side of the core layer, where the skin layer contains a polyolefin that may be a high density polyethylene (HDPE), medium density polyethylene (MDPE), linear low density polyethylene (LLDPE), and/or low density polyethylene (LDPE). The core layer can make up at least 34% of the thickness of the structure and each skin layer can make up from 1 to 33% of the thickness of the structure. The structure can have an increased dart drop impact value as compared with a core structure of total equal thickness absent the skin layer.

The ICP can have a density of ranging from 0.89 to 0.92 gr/cm³, can have a polydispersity Mw/Mn ranging from 4 to 12, and can have a melt flow rate ranging from 0.1 to 3.5 g/10 min.

At least one skin layer can include a polyethylene having a melt index ranging from 0.1 to 3.0 g/10 min, a melting point ranging from 115 to 130° C., and a density ranging from 0.912 to 0.950 gr/cm³.

At least one skin layer can include a metallocene catalyzed polyethylene (mPE) having a melt index ranging from 0.1 to 3.0 g/10 min, a density ranging from 0.912 to 0.950 gr/cm³, a melting point ranging from 115 to 125° C., and a polydispersity Mw/Mn of less than 4.0.

The core layer can range in thickness between 10 to 150 microns, and each skin layer can range in thickness between 3.5 to 50 microns. The skin layers can be the same polyolefin.

The structure can have a reduced haze and increased gloss as compared with a core structure of total equal thickness absent the skin layer. The structure can have an increased tear resistance compared with a core structure of total equal thickness absent the skin layer.

The invention can further include an article made from the co-extruded film or sheet structure of the present invention.

An embodiment of the invention can include a layered co-extruded film or sheet structure having a core layer of essentially of an ICP and at least one skin or intermediate layer adjacent to each side of the core layer. The skin layers being essentially an mPE.

The ICP can have a polydispersity from 4 to 12, a melt flow rate from 0.1 to 3.5 g/10 min, and xylene solubles of 25% or less.

The skin layer can be a mPE having a melt index of from 0.1 to 3.0 g/10 min, a density of 0.910 to 0.950 gr/cm³, a melting point of 115 to 127° C., and a polydispersity Mw/Mn of less than 4.0.

The core layer can range in thickness from between 10 to 150 microns and comprises at least 34% of the thickness of the structure, and where each skin layer ranges in thickness between 3.5 to 50 microns and comprises from 1 to 33% of the thickness of the structure.

The structure can have reduced haze and increased gloss as compared with a core structure of total equal thickness absent the skin layer. The structure can have an increased dart drop strength compared with a core structure of total equal thickness absent the skin layer. The structure can have an increased tear resistance compared with a core structure of total equal thickness absent the skin layer.

An embodiment of the invention can be a co-extruded film or sheet structure having a core layer of an ICP, the core layer ranging in thickness between 10 to 150 microns, and a first skin and a second skin, each adjacent to a side of the core layer of mPE, each skin layer ranging in thickness between 3.5 to 35 microns, the core layer comprises at least 34% of the thickness of the structure and each skin layer comprises from 1 to 33% of the thickness of the structure, the structure having an increased dart drop strength and tear resistance as compared with a core structure of total equal thickness absent the skin layer.

The ICP can have a polydispersity from 4 to 12, a melt flow rate from 0.5 to 5.0 g/10 min and xylene solubles of 25% or less. The mPE can have a melt index of from 0.1 to 3.0 g/10 min and a melting point of 115 to 128° C.

In another embodiment, there is provided in another non-limiting form, a co-extruded film or sheet structure that includes a core layer containing at least one broad molecular weight distribution ethylene/propylene rubber impact-modified heterophasic copolymer. The core layer ranges in thickness between 10 to 150 microns. The co-extruded structure also includes at least one skin or intermediate layer on each side of the core layer comprising a polyolefin that may be a HDPE, MDPE, LLDPE, and/or LDPE. The skin layer ranges in thickness between 3.5 to 50 microns. The structure has reduced haze and increased gloss as compared with a core structure of total equal thickness absent the skin layer. The structure has increased dart drop strength and tear resistance as compared with a core structure of total equal thickness absent the skin layer.

### BRIEF DESCRIPTION OF DRAWINGS

FIG. 1 is a web graph comparison of properties of a co-extruded film of the present invention with a commercial film.

FIG. 2 is a web graph comparison of properties of a co-extruded film of the present invention with a monolayer film of mPE.

FIG. 3 is a web graph comparison of properties of a co-extruded film of the present invention with a monolayer film of PP.

FIG. 4 is a web graph comparison of properties of a co-extruded film of the present invention with a monolayer film of 60% mLLDPE and 40% MDPE.

### DETAILED DESCRIPTION

In some specific applications, such as bags where clarity is needed, it has been discovered that the use of polyethylene adhered to impact copolymers in a multilayer structure can exhibit mechanical and barrier property benefits.

It has further been discovered that broad molecular weight distribution ethylene/propylene rubber impact-modified heterophasic copolymers (ICPs) such as Total Petrochemicals PP 4170 may be advantageously co-extruded with medium density polyethylene or random copolymers having a majority polyethylene, to give blown films and sheet material structures having improved properties. It has been found this combination works synergistically in giving structures with better optical characteristics, but that still retain dart drop and tear resistance characteristics of single layer ICP films.

The broad molecular weight distribution ethylene/propylene rubber impact-modified heterophasic copolymer (ICP) that is the primary or only polymer used in the core layer may be one having a polydispersity from 4 to 12, a melt flow rate from 0.1 to 3.5 g/10 min, and xylene solubles of 25% or less. Impact copolymers falling within this definition include, but are not necessarily limited to Total Petrochemicals PP 4180, PP 4170, PP 4280W, and PP 4320. In a non-limiting embodiment, the ICP may have a polydispersity from 5 to 10. In another non-limiting embodiment, the impact copolymer may have a melt flow rate from 0.2 to 2.5 g/10 min, alternately from 0.3 to 2.0 g/10 min. In another non-limiting embodiment, the impact copolymer may have xylene solubles of 25% or less. In an alternate non-limiting embodiment, the xylene solubles may range from 10 to 25 wt %, and in another alternative from 15 to 25 wt %. In another non-limiting embodiment, the impact copolymer may have a melting point ranging from 155 to 170° C. In an alternate non-limiting embodiment, the impact copolymer may have a melting point ranging from 158 to 166° C. In an alternate non-limiting embodiment, the impact copolymer may have a melting point ranging from 160 to 165° C. The density of the impact copolymer may range from 0.88 to 0.93 gr/cm³ in one non-limiting embodiment, in an alternate embodiment from 0.89 to 0.92 gr/cm³, and from 0.9 to 0.91 gr/cm³ in an alternate embodiment. And in still another non-limiting embodiment the ethylene content of the impact copolymer may range from 7 to 15 wt %, and alternatively from 9 to 14 wt %. Methods for making ICP's are well known in the art, for instance, in one non-limiting embodiment methods and techniques as described in U.S. Pat. No. 6,657,024, incorporated herein by reference, may be used. The ICP can have a weight average molecular weight distribution (MWD) ranging from 280,000 to 840,000, alternatively in another non-limiting embodiment ranging from 320,000 to 780,000, and alternatively in another non-limiting embodiment ranging from 420,000 to 700,000.

The impact copolymer may be co-extruded with one or more second polyolefin that forms at least one skin layer on both, opposing sides of the core layer. The skin layers may be symmetrical, that is, have essentially the same thickness and composition. In another non-restrictive embodiment, in the case where at least one skin layer is on either side of the core layer, the skin layers may be asymmetrical, i.e., have different thicknesses and compositions. In an alternate, non-limiting embodiment, there may be more than one skin layer on one or the other side of the core layer. Methods for making co-extruded polyolefins and various compositions of co-extruded polyolefins are disclosed in U.S. patent application Ser. No. 11/026,848 filed on Dec. 30, 2004, which is incorporated by reference herein in its entirety.

One suitable, second polyolefin useful for coextruding with ICP is polyethylene or polyethylene based copolymer compounds, such as those polymerized using Ziegler-Natta or single-site catalysts. The Ziegler-Natta catalysts may typically be conventional Ziegler-Natta catalysts of the type disclosed, for example, in U.S. Pat. Nos. 4,298,718 and 4,544,717, both to Mayr, et al., as non-limiting examples, both incorporated by reference herein in their entirety.

Catalysts employed in the polymerization of α-olefins may be characterized as supported catalysts or unsupported catalysts, sometimes referred to as homogeneous catalysts. The so-called conventional Ziegler-Natta catalysts are stereospecific complexes formed from a transition metal halide and a metal alkyl or hydride, such as titanium tetrachloride supported on an active magnesium dichloride. A supported catalyst component includes, but is not necessarily limited to, titanium tetrachloride supported on an “active” anhydrous magnesium dihalide, such as magnesium dichloride or magnesium dibromide. A supported catalyst component may be employed in conjunction with a co-catalyst such as an alkylaluminum compound, for example, triethylaluminum (TEAL). The Ziegler-Natta catalysts may also incorporate an electron donor compound that may take the form of various amines, phosphenes, esters, aldehydes, and alcohols.

Single site catalyzed polyolefins can differ from Ziegler-Natta catalyzed polyolefins in terms of molecular structure, particularly molecular weight and co-monomer distribution. The single site catalysts, such as metallocene catalysts, can create polyolefins with a narrow molecular weight distribution. Polyethylenes falling within this definition include, but are not necessarily limited to Total Petrochemicals mPE M2710EP.

Metallocene catalysts are coordination compounds or cyclopentadienyl groups coordinated with transitional metals through π-bonding. Metallocene catalysts are often employed as unsupported or homogeneous catalysts, although they also may be employed in supported catalyst components. With respect to the metallocene random copolymers, this term denotes polymers obtained by copolymerizing ethylene and an α-olefin, such as propylene, butene, hexene or octene, in the presence of a monosite catalyst generally consisting of an atom of a metal which may, for example, be zirconium or titanium, and of two cyclic alkyl molecules bonded to the metal. More specifically, the metallocene catalysts are usually composed of two cyclopentadiene-type rings bonded to the metal. These catalysts are often used with aluminoxanes as cocatalysts or activators, in one non-limiting embodiment methylaluminoxane (MAO). Hafnium may also be used as a metal to which the cyclopentadiene is bound. Other metallocenes may include transition metals of groups IVA, VA and VIA. Metals of the lanthanoid series may also be used.

In the case where the skin layer is a metallocene-catalyzed polyethylene (mPE), the mPE can be made using any suitable metallocene catalyst or metallocene catalyst system, such as is generally known in the art. In one non-limiting embodiment, the mPE has a melt index of from 0.10 to 3.0 g/10 min, a density of 0.910 to 0.950 gr/cm³, a melting point of 110° C. to 135° C., and polydispersity Mw/Mn of less than 4.0. Metallocene-based resins falling within this definition include, but are not necessarily limited to Total Petrochemicals mPE M3410EP and M2710EP medium density polyethylene resins. In one non-limiting embodiment the mPE may be one having a melt index of from 0.50 to 2.0 g/10 min, alternatively in another non-limiting embodiment ranging from 0.80 to 1.0 g/10 min. The mPE may be one having a density of 0.92 to 0.94 gr/cm³, alternatively in another non-limiting embodiment ranging from a density of 0.92 to 0.93 gr/cm³. The mPE may be one having a melting point of 115° C. to 125° C., alternatively in another non-limiting embodiment ranging from 118° C. to 123° C. The mPE can have a weight average molecular weigh distribution (MWD) ranging from 30,000 to 110,000, alternatively in another non-limiting embodiment ranging from 40,000 to 100,000, and alternatively in another non-limiting embodiment ranging from 50,000 to 90,000.

In another non-restrictive embodiment the skin layer may be a medium density polyethylene (MDPE), such as is generally known in the art, for example a ZN catalyzed MDPE. In one non-limiting embodiment, the MDPE has a density of 0.926 to 0.940 gr/cm³.

In another non-restrictive embodiment the skin layer may be a high density polyethylene (HDPE), such as is generally known in the art. In a non-limiting embodiment, the HDPE has a density of 0.940 gr/cm³ or greater.

In another non-restrictive embodiment the skin layer may be a linear low density polyethylene (LLDPE), such as is generally known in the art. In one non-limiting embodiment, the LLDPE has a density of from 0.910 to 0.925 g/cm³.

In another non-restrictive embodiment the skin layer may be a low density polyethylene (LDPE), such as is generally known in the art. In one non-limiting embodiment, the LDPE has a density of from 0.910 to 0.940 g/cm³.

Blends of polymers may be employed for the core layer and/or the skin layers of the film structures, and the blends may be prepared using technologies known in the art, such as the mechanical mixing of the polyolefins using high-shear internal mixers of the Banbury type, or by mixing directly in the extruder. Suitable extruders include, but are not limited to, single screw, co-rotating twin-screws, contra-rotating twin-screws, BUSS extruders, and the like. Although special blending equipment and techniques are acceptable, in one non-limiting embodiment the blends are made using the conventional extruders associated with blown film production lines.

The polymers and blends of polymers may also contain various additives capable of imparting specific properties to the articles the blends are intended to produce. Additives known to those skilled in the art that may be used in these blends include, but are not necessarily limited to, fillers such as talc and calcium carbonate, pigments, antioxidants, stabilizers, anti-corrosion agents, slip agents, UV stabilizing agents and antiblock agents, etc.

In further processing the polymers are co-extruded with other resins to form multilayer films. The co-extrusion may be conducted according to methods well known in the art. Co-extrusion may be carried out by simultaneously pushing the polymer of the skin layer and the polymer of the core layer through a slotted or spiral die system to form a film formed of an outer layer of the skin polymer and substrate layer of the core polymer. As mentioned, additional layers may also be coextruded, either as an additional skin layer on the other surface of the substrate core layer, or layers serving other functions, such as barriers, anti-block layers, heat-sealing layers etc. Alternatively, a skin layer may be extrusion coated later in the film making process. In one non-limiting embodiment the skin layer may be relatively thick, and the skin layer smoothes the surface of the impact copolymer core. Also, other layers may be added to create a more complex film after or contemporaneous with the formation of the basic film or sheet structure. In one non-limiting embodiment the co-extruded film or sheet structure has a core layer ranging in thickness between 10 to 150 microns, and the skin layer ranges in thickness between 3.5 to 50 microns. In a non-limiting embodiment the co-extruded film or sheet structure has a core layer of at least 34% of the structure thickness, and the skin layer on each side of the core layer is from 1 to 33% of the structure thickness. Furthermore, the film or sheet materials may be laminated with other materials after extrusion as well. Known techniques in laminating sheets and films may be applied to form these laminates.

Articles that may be formed with these co-extruded films or sheet structures include, but are not necessarily limited to, heavy-duty bags and shipping sacks, carrier envelopes, FFS film, food packaging, tissue & towel overwraps, pet food bags, industrial films, and the like.

In the foregoing specification, the films, sheet structures and methods have been described with reference to specific embodiments thereof, and has been demonstrated as effective in providing films having improved properties. Various modifications and changes may be made without departing from the scope of the invention as set forth in the appended claims. Accordingly, the specification is to be regarded in an illustrative rather than a restrictive sense. For example, specific combinations or proportions of polymers and other components falling within the claimed parameters, but not specifically identified or tried in a particular polymer laminate structure, are anticipated and expected to be within the scope of this invention. Further, these methods are expected to work at other conditions, particularly extrusion and blowing conditions, than those exemplified herein. The methods, films and structures discussed herein will now be described further with respect to an actual Example that is intended to further illustrate the concept and not to limit it in any way.

### Example

Example 1 is a blown film co-extrusion of a PP ICP core having a skin layer on each side of the core made of a metallocene medium density PE. A 2.5 mil film composed of an A/B/A three layer co-extrusion structure with a 15/70/15 layer distribution was made using a Davis-Standard co-extruder with the conditions listed in Table 2 and Table 3.

Polypropylene Impact Copolymer PP 4170 was used in the core layer (layer B) and medium density polyethylene mPE M2710EP was used for the skin layers (layers A), both of which are commercially available from Total Petrochemicals USA, Inc.

The comparative examples are 2.5 mil thick films. Comparative Example 2 is a commercially available heavy-duty shipping sack (HDSS) film that is used as a baseline for comparative purposes. Comparative Example 3 is a monolayer made entirely of PP 4170, the material used in the core layer of Example 1. Comparative Example 4 is a monolayer made entirely of mPE M2710EP, the material used in the skin layers of Example 1. Comparative Example 5 is a monolayer made of a blend consisting of 60% mLLDPE and 40% MDPE. A comparison of various film properties is in Table 1. The Tear Strength of Example 1 was compared to Example 3 the monolayer PP film. Example 3 had a tear resistance of 39 g while the co-extrusion film of Example 1 had a tear strength of 50 g.

Using the commercial HDSS film as a baseline it can be seen that the three layer co-extrusion film of Example 1 gives an improvement in five properties that were tested: 1% Secant Modulus, Tensile Strength at Yield, Elongation, Gloss and Dart Drop Impact. Example 1 also has a lower Haze than Comparative Examples 3 and 5, and Haze was comparable to comparative Example 4. Example 1 achieved results of a high performing film in each of the physical and optical tests and was the only film tested that gave results that exceeded the baseline in each of the five properties tested.

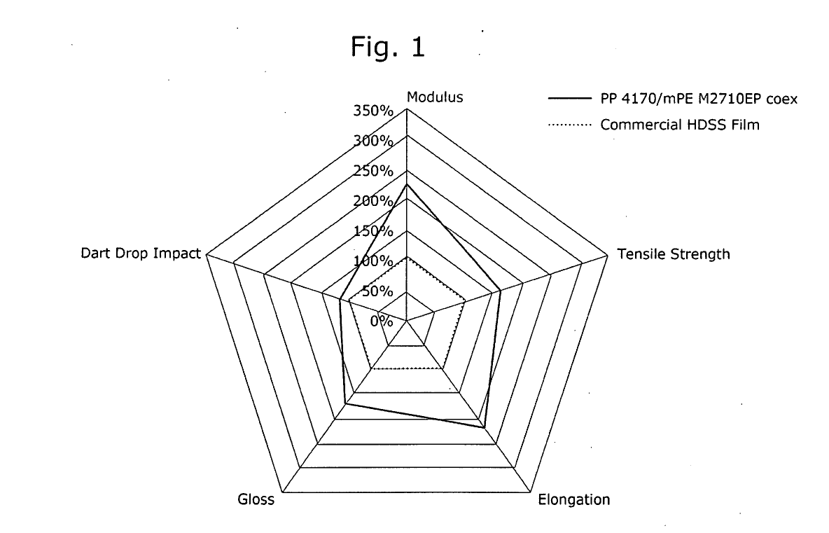

The data from Table 1 is shown as comparative web graphs in FIGS. 1-4. In each of FIGS. 1-4, Comparative Example 2 is used as the 100% baseline. FIG. 1 illustrates the comparison of properties of Example 1 and Comparative Example 2. Each of the five properties of Example 1 is higher than Comparative Example 2.

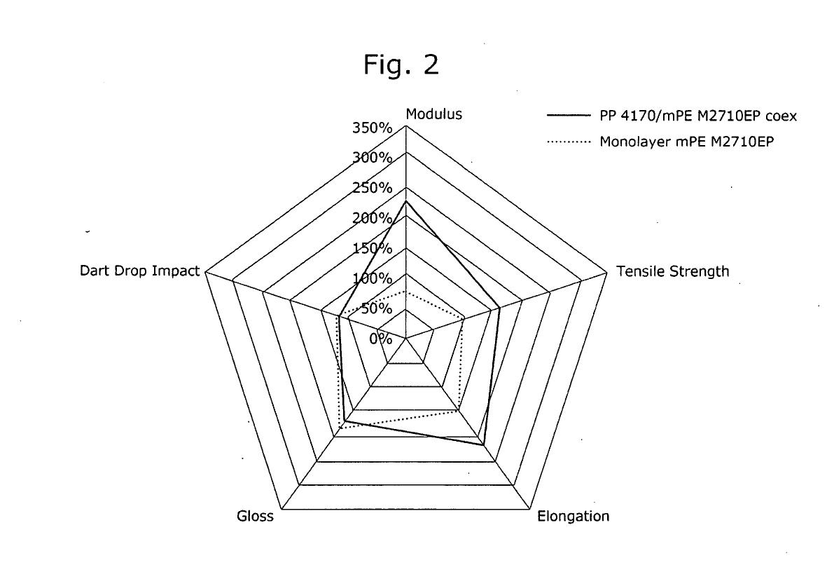

FIG. 2 illustrates the comparison of properties of Example 1 and Comparative Example 4, which is a monolayer mPE. Example 1 is higher than Comparative Example 4 in Modulus, Tensile Strength and Elongation, and is comparable in Gloss and Dart Drop Impact.

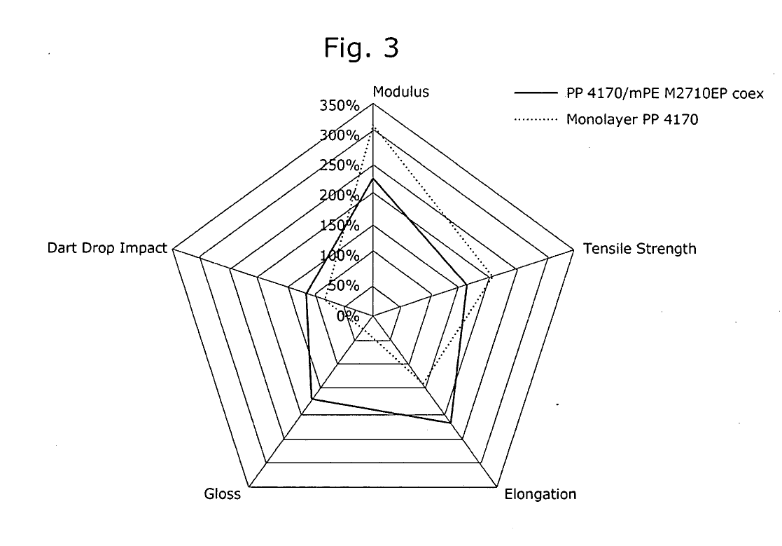

FIG. 3 illustrates the comparison of properties of Example 1 and Comparative Example 3, which is a monolayer PP. Example 1 is higher than Comparative Example 3 in Modulus and Tensile Strength and Elongation, and is comparable in Dart Drop Impact.

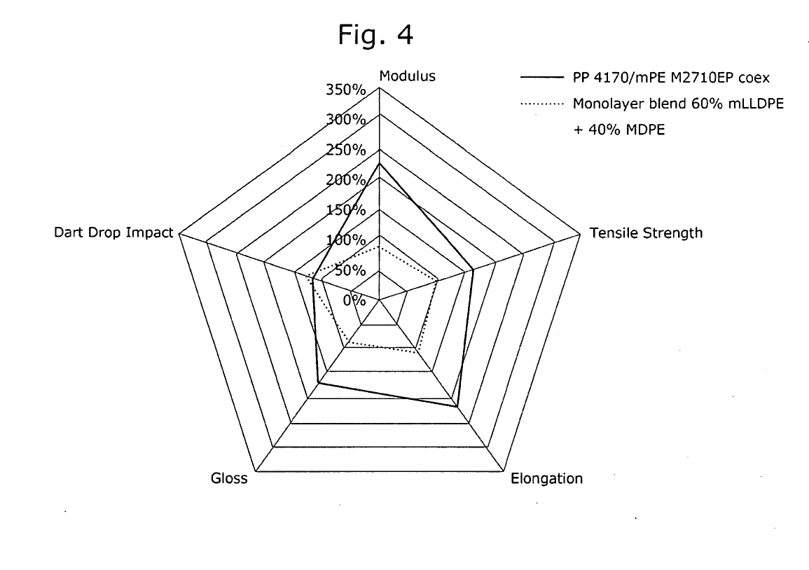

FIG. 4 illustrates the comparison of properties of Example 1 and Comparative Example 5, which is a monolayer blend consisting of 60% mLLDPE and 40% MDPE. Example 1 is higher than Comparative Example 5 in Modulus, Tensile Strength, Gloss and Elongation, and is comparable in Dart Drop Impact.

TABLE 1

| | Example 1 | Comp. Ex 2 | | Comp. Ex 4 | Comp. Ex 5 |
|---|---|---|---|---|---|
| | Coextruded | Commercial | Comp. Ex 3 | mPE | 60% mLLDPE/ |
| | 4170/M2710 | HDSS Film | PP4170 | M2710EP | 40% MDPE |
| Modulus | 102 | 45 | 141 | 35 | 39 |
| (kpsi) | | | | | |
| Tensile | 3,262 | 2,000 | 4,153 | 2,000 | 2,000 |
| Strength | | | | | |
| (psi) | | | | | |
| Elongation | 22 | 10 | 14 | 15 | 11 |
| (%) | | | | | |
| Haze (%) | 12 | NA | 60 | 8 | 22 |
| Gloss | 60 | 35 | 10 | 65 | 30 |
| Dart Drop | 290 | 250 | 209 | 300 | 320 |
| Impact (g) | | | | | |
| | INVENTION | BASELINE | | | |
| Modulus | 227% | 100% | 313% | 78% | 87% |
| Tensile | 163% | 100% | 208% | 100% | 100% |
| Strength | | | | | |
| Elongation | 219% | 100% | 140% | 150% | 110% |
| Gloss | 171% | 100% | 29% | 186% | 86% |
| Dart Drop | 116% | 100% | 83% | 120% | 128% |
| Impact | | | | | |

TABLE 2
Materials and Structures Used in Example 1

| Example | Example 1 |
|---|---|
| Skin layer A (microns) | mPE M2710EP (9.5) |
| Core layer B (microns) | PP 4170 (44.5) |
| Skin layer C (microns) | mPE M2710EP (9.5) |
| Total target thickness, | 2.5 (63.5) |
| mil (microns) | |

TABLE 3
Processing Conditions Used in Example 1

| Variable | Unit | Value |
|---|---|---|
| Width | mm | 238 |
| Blow Up Ratio (BUR) for all structures | | 2.5 |
| Die diameter | mm | 60 |
| Temp. profile for Extruders 1 & 3 (skin) | ° C. | 196-204 (PE) |
| Temp. profile for Extruder 2 (core) | ° C. | 196-232 (PP) |
| Cooling system | | Single air ring |
| Cooling air temp. | ° C. | 2 |

TABLE 4
ASTM Film Test Methods Used

| Property | ASTM Procedure |
|---|---|
| Tensile Strength, Elongation, Secant Modulus | D882 |
| Haze | D1003 |
| Gloss | D2457 |
| Melt Flow Rate | D1238 - 230° C./2.16 kg |
| Melting Point | D3418 |
| Melt Index | D1238 - 190° C./2.16 kg |

### GLOSSARY

4170 Total Petrochemicals PP 4170 polypropylene is a fractional melt flow impact copolymer (ICP) produced with a Ziegler-Natta catalyst, available from Total Petrochemicals USA, Inc.
M2710EP Total Petrochemicals mPE M2710EP MDPE is a medium density polyethylene produced with a metallocene catalyst whose melt index is published as 0.90 g/10 min, with a density published as 0.927 gr/cm³, available from Total Petrochemicals USA, Inc.
LDPE Low density polyethylene is generally considered to have a density range from 0.910 to 0.940 g/cm³. LDPE generally has a high degree of short and long chain branching.
LLDPE Linear low density polyethylene is generally considered to have a density range of 0.910 to 0.925 g/cm³. LLDPE is a substantially linear polymer with significant numbers of short branches (made by copolymerization of ethylene with short-chain alpha-olefins such as 1-butene, 1-hexene or 1-octene).
HDPE High density polyethylene is generally considered to have a density of greater than or equal to 0.941 g/cm³ and a relatively low degree of branching.
MDPE Medium density polyethylene is generally considered to have a density range of 0.926 to 0.940 g/cm³ and a relatively low degree of branching.
mPE Polyethylene produced with a metallocene catalyst, generally considered to have a density ranging from 0.910 gr/cm³ to 0.950 gr/cm³, which can include mLLDPE, mMDPE, and mHDPE.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A layered co-extruded film or sheet structure comprising:
a core layer having a first and second side, comprising at least one polypropylene based impact copolymer (ICP); and
at least one skin or intermediate layer adjacent to the first and second sides of the core comprising at least one polyolefin chosen from the group of high density polyethylene (HDPE), medium density polyethylene (MDPE), linear low density polyethylene (LLDPE), and/or low density polyethylene (LDPE);
wherein the core layer comprises at least 34% of the thickness of the structure and each skin layer comprises from 1 to 33% of the thickness of the structure;
wherein the structure has increased dart drop impact value as compared with a core structure of total equal thickness absent the skin layer.

2. The co-extruded film or sheet structure of claim 1, wherein the ICP has a density of from 0.89 to 0.92 gr/cm³, a polydispersity from 4 to 12, and a melt flow rate from 0.1 to 3.5 g/10 min.

3. The co-extruded film or sheet structure of claim 1, wherein at least one skin layer comprises a polyethylene having a melt index of from 0.1 to 3.0 g/10 min, a melting point of 115 to 130° C., and a density of from 0.912 to 0.950 gr/cm³.

4. The co-extruded film or sheet structure of claim 1, wherein at least one skin layer is a metallocene catalyzed polyethylene (mPE) having a melt index of from 0.1 to 3.0 g/10 min, a density of 0.912 to 0.950 gr/cm³, a melting point of 115 to 125° C., and polydispersity Mw/Mn of less than 4.0.

5. The co-extruded film or sheet structure of claim 1, wherein the core layer ranges in thickness between 10 to 150 microns, and where each skin layer ranges in thickness between 3.5 to 50 microns.

6. The co-extruded film or sheet structure of claim 1, wherein the skin layers comprise the same polyolefin.

7. The co-extruded film or sheet structure of claim 1, wherein the structure has reduced haze and increased gloss as compared with a core structure of total equal thickness absent the skin layer.

8. The co-extruded film or sheet structure of claim 1, wherein the structure has increased tear resistance compared with a core structure of total equal thickness absent the skin layer.

9. An article made from the co-extruded film or sheet structure of claim 1.

10. A layered co-extruded film or sheet structure comprising:
a core layer having a first and second side, consisting essentially of a polypropylene rubber impact-modified heterophasic copolymer (ICP), and
at least one skin or intermediate layer adjacent to the first and second sides of the core consisting essentially of a metallocene catalyzed polyethylene (mPE).

11. The co-extruded film or sheet structure of claim 10, wherein the ICP has a polydispersity from 4 to 12, a melt flow rate from 0.1 to 3.5 g/10 min, and xylene solubles of 25% or less.

12. The co-extruded film or sheet structure of claim 10, wherein the skin layer is a metallocene catalyzed polyethylene (mPE) having a melt index of from 0.1 to 3.0 g/10 min, a density of 0.910 to 0.950 gr/cm³, a melting point of 115 to 127° C., and a polydispersity Mw/Mn of less than 4.0.

13. The co-extruded film or sheet structure of claim 10, wherein the core layer ranges in thickness between 10 to 150 microns and comprises at least 34% of the thickness of the structure, and where each skin layer ranges in thickness between 3.5 to 50 microns and comprises from 1 to 33% of the thickness of the structure.

14. The co-extruded film or sheet structure of claim 10, wherein the structure has reduced haze and increased gloss as compared with a core structure of total equal thickness absent the skin layer.

15. The co-extruded film or sheet structure of claim 10, wherein the structure has increased dart drop strength and tear resistance compared with a core structure of total equal thickness absent the skin layer.

16. An article made from the co-extruded film or sheet structure of claim 10.

17. A co-extruded film or sheet structure comprising:
a core layer comprising a polypropylene impact copolymer (ICP), wherein the core layer ranges in thickness between 10 to 150 microns, and
a first skin and a second skin, each adjacent to a side of the core layer comprising metallocene catalyzed polyethylene (mPE), wherein each skin layer ranges in thickness between 3.5 to 35 microns;
wherein the core layer comprises at least 34% of the thickness of the structure and each skin layer comprises from 1 to 33% of the thickness of the structure;
wherein the structure has increased dart drop strength and tear resistance as compared with a core structure of total equal thickness absent the skin layer.

18. The co-extruded film or sheet structure of claim 17, wherein the structure has reduced haze and increased gloss compared with a core structure of total equal thickness absent the skin layer.

19. The co-extruded film or sheet structure of claim 17, wherein the ICP has a polydispersity from 4 to 12, a melt flow rate from 0.5 to 5.0 g/10 min, and xylene solubles of 25% or less.

20. The co-extruded film or sheet structure of claim 17, wherein the mPE has a melt index of from 0.1 to 3.0 g/10 min and a melting point of 115 to 128° C.
